(19) United States
(12) Patent Application Publication
(10) Pub. No.: US 2002/0014544 A1
(43) Pub. Date: Feb. 7, 2002

(54) Sealing nozzle

(76) Inventor: Michael Holmstrom, Finja (SE)

Correspondence Address: BOYLE FREDRICKSON NEWHOLM STEIN & GRATZ S.C., SUITE 1030, 250 EAST WISCONSIN AVENUE, MILWAUKEE, WI, 53202, US

(21) Appl. No.: 09/879,245

(22) Filed: Jun. 8, 2001

(30) Foreign Application Priority Data
Dec. 8, 1999 (SE) PCT/SE99/02290
Dec. 8, 1998 (SE) 9804244-3

(51) Int. Cl. B05B 1/02

(52) U.S. Cl. 239/597; 239/601

(57) ABSTRACT

The present invention relates to a nozzle intended for the application of fluid materials, which at a front end thereof has an aperture opening into a slot. A central portion of said slot is functioning to release most of the material straight ahead. Furthermore, the slot has side portions functioning to release material in sideway directions. In a preferred embodiment, said front end is shaped like a truncated cone with a flat top, in which said slot is formed. The slot is thus divided into three straight portions with the central portion in the flat top and the angle of the side portions defined by the top angle of said cone. Under certain conditions, the jets of material released from the various portions are held together by a surface tension. As most of the material is released from the central portion, the jets from the angled side portions will be deflected towards the center jet, resulting in a jet with a relatively even width, and a resultant coating being thickest in the middle.

### FIELD OF THE INVENTION

The present invention relates to a technique for application, via a nozzle, of fluid materials in a controlled manner. More particularly, the invention relates to a nozzle for the application of a sealant or a glue, e.g. onto the joints of car bodies.

### BACKGROUND

In assemblies comprising sheet metal work, there will typically be joints. These joints will occur e.g. where two or more pieces of sheet metal are joined with a certain overlap. Various techniques for joining sheet metal components are e.g. welding, riveting or gluing. For various reasons, not least cost reasons, spot welding is often used. This means that the sheets are joined by discrete spot welds, spaced along the joint. The joint then achieved, in the form of spot welds, will thus exhibit a certain similarity to a riveted seam or joint. Overlapping joints between plates joined together could provide a source of corrosion damage, as moisture might be drawn into the joint by capillary forces. Consequently, is often desirable to seal the joint with some water-resistant material, especially for sheet metal constructions to be used in outdoor applications.

A typical example where the above technique is utilised, is the design of car bodies. A car body typically consists of a multitude of sheet metal parts, joined through spot welding. Most of these joints between such sheet metal parts are, in the finished car, hidden from view behind panels, seats, etc. In order to protect these joints from corrosion caused by e.g. condensation, a sealant is usually applied onto the overlapping joint. Similar to the welding itself, the sealant application is normally performed by robots, spraying on the sealant through nozzles. The robot will follow the welded seam and apply sealant onto the joint, and it is desirable for the sealant to cover the joint with an overlap that is appropriate for the application. There is however no need for applying any sealant far beside the joint.

An important factor when applying the sealant is how well the robot can follow edges and bends in the joint; a car does not consist of many straight weld joints. This may be achieved by the robot following a predetermined, computer-stored movement pattern, corresponding to the layout of the weld seams of the body. One problem with such a technique is, however, that the dimensional accuracy in a car body is typically a couple of millimeters. Thus, a certain flexibility is demanded of the robot, and especially of its nozzle, allowing a satisfactory application of the sealant onto the joint, in spite of the nozzle being somewhat closer to, or somewhat further away from, the joint than assumed by the robot. Another way of resolving the problem of making the robot follow the weld seams is to provide it with a distance sensor in association with the nozzle, or alternatively, with some type of sensing means, trailing the sheet metal and thus sensing the actual distance from the robot nozzle to the joint. Such systems may however have other disadvantages, such as a higher cost, but also by occupying space in the robot head.

FIG. 1 illustrates a prior art nozzle, used for the application of sealant onto sheet metal joints. The nozzle is characterised by its aperture being a slot in a curved portion. As is also illustrated in the figure, the material supplied via the nozzle passage will leave the slot in a generally radial direction, from the curved portion. The material will thus be sprayed in a flat cone configuration, which is also a common denomination for this type of nozzle (flat cone). This spraying technique will provide a relatively even thickness of sealant material over the joint portion. The thickness as well as the width of the applied sealant material will however be directly dependent of the distance between the nozzle and the substrate; a longer distance will provide a thinner coating over a wider area. Should the application distance increase above a certain value, the jet might be split into smaller jets in an uncontrolled manner.

Another type of prior art nozzle is shown in FIG. 2. This nozzle is similar to that of oil burners and has an interior chamber where a vortex is formed when the material is extruded. The nozzle opening may also be threaded, in order to enhance the vortex movement. When the material is ejected, the jet will have the form of a hollow cone or comet, as illustrated in the figure. As the jet is conical, this nozzle exhibits the same distance sensitivity as the nozzle discussed in connection with FIG. 1. Furthermore, as the nozzle is passed along a joint, the coating will be thicker along the sides than in the middle, where the material is best needed.

### OBJECT OF THE INVENTION

The object of the present invention is to provide a nozzle overcoming the described disadvantages of the prior art. More particularly, it is an object of the present invention to provide a nozzle for application of a coating, e.g. a sealant, so constituted as to be less sensitive to the distance between said nozzle and the surface onto which the coating is to be applied, than prior art nozzles. It is a further object of the present invention to provide a nozzle that is functioning to distribute the material, over the application surface covered, in such a way that an improved sealing is provided with a given amount of material, compared to the prior art.

### SUMMARY OF THE INVENTION

The present invention relates to a nozzle, intended for the application of fluid materials, which at a front end thereof has an aperture which opens into a slot. A central portion of said slot is intended to release most of the material straight ahead. Furthermore, the slot has side portions functioning to release material in sideways directions. In a preferred embodiment, said front end is shaped like a truncated cone with a flat top, in which said slot is formed. The slot will thus be divided into three portions, with the central portion in the flat top and the angle of the side portions defined by the top angle of said cone. The nozzle is provided with a through passage from its rear end up to the slotted aperture, allowing a material under pressure to be forced through the nozzle from its rear end and out through its slotted aperture.

The three-part profile of the aperture causes the material jet forced out through the nozzle to want to split into three smaller jets. If the pressure of the material lies below a certain level, the jets will, however, be kept together by the surface tension, despite the corners between the side portions and the central portion. Dependent upon the material to be used and the reological properties thereof, different spraying pressures and angles are suitable. Most of the material is ejected through the central portion, which is open in the same direction as said through passage, whereby said surface tension primarily causes the two smaller side jets to be deflected towards the centre jet. As a consequence, the jet will have a comparatively even width over a prolonged distance, providing a wide useful application distance range. As most of the material is extruded through the central portion, the coating profile will furthermore have the greatest thickness at the centre, i.e, at the joint where the material is required.

### BRIEF DESCRIPTION OF THE DRAWINGS

FIG. 1 shows a prior art nozzle generating a jet in the form of a flat cone;

FIG. 2 shows a prior art nozzle creating a jet in the form of a hollow cone;

FIGS. 3a, 3b and 3c show various views of an embodiment of the invention;

FIG. 3d shows a nozzle according to the present invention creating a Jet with an enlarged working range.

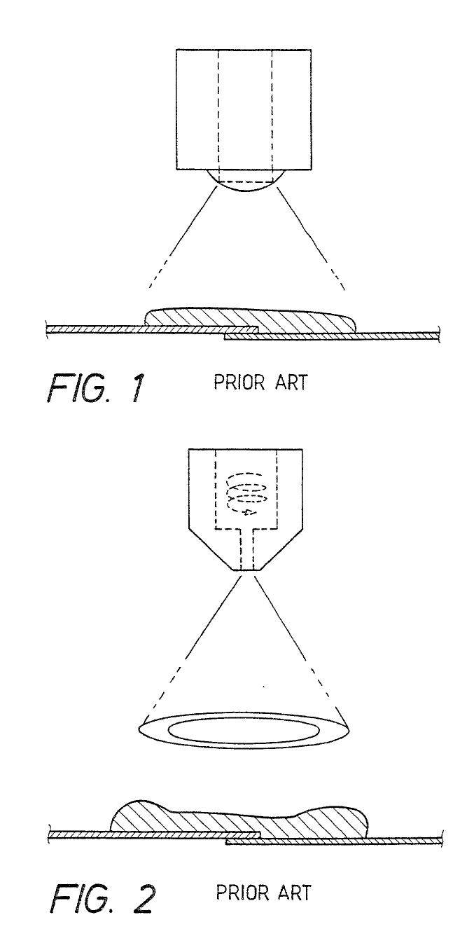

### DETAILED DESCRIPTION OF A PREFERRED EMBODIMENT

The invention relates to a nozzle for the application of a sealant or a glue, e.g. onto joints of car bodies. Two general problems with the prior art has been discussed; sensitivity to variations in the application distance, and distribution of the material on the coated surface. The present invention will solve both these problems through a nozzle, the aperture of which opens in a slot having a central portion, functioning to release most of the material straight ahead. The nozzle according to the present invention further exhibits side portions of said slot, functioning to release material towards the sides. Said central portion and side portions may be rectilinear or curved. Adjacent rectilinear portions are separated by corners, whereas adjacent curved portions are separated by having different radii of curvature and/or centres of curvature. Irrespective of the specific design, the basic idea behind the present invention is that material being released from adjacent portions of said slot will be kept together by the surface tension in the material, even though the material is released at different exit angles.

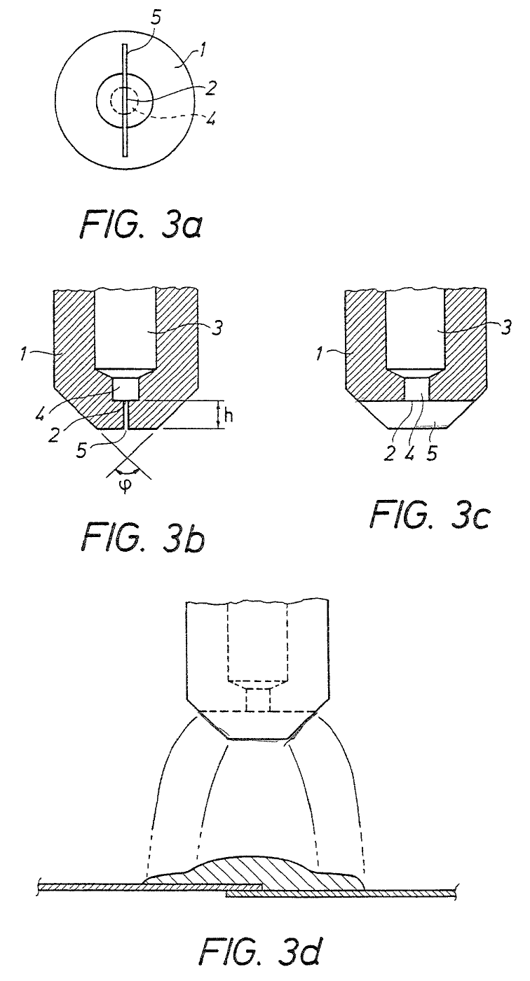

A preferred embodiment, exhibiting a three-part slot, will be described below with reference to FIGS. 3a to 3d.

FIGS. 3a to 3c show a preferred embodiment of the nozzle 1 according to the invention, in three different views. FIG. 3a shows the nozzle from below, i.e. its front opening 2 is directed outwards from the paper sheet. FIG. 3a reveals that the nozzle I has a substantially circular longitudinal cross-section; this is however only to be regarded as an example, as this part of the nozzle shape is of no decisive importance for the invention. Thus, this cross-section could just as well be rectangular. In FIG. 3b, the nozzle 1 is shown in a cross-sectional side view. The rear end of the nozzle 1, the upper portion in FIG. 3b, is not shown in full, as this portion of the nozzle is of no decisive importance for the invention. The front section of the nozzle 1, the lower portion in FIG. 3b, has the shape of a truncated cone. In another embodiment, having a rectangular cross-section, this cone would rather be a pyramid. The cone top angle φ is indicated in the figure. A passage 3, through which material is intended to flow, runs through the entire nozzle 1 from its rear end to the aperture 2 at its front end. The passage 3 is relatively wide and preferably cylindrical. in a preferred embodiment, as shown in the figure, the passage 3 has a narrower portion 4 just before the aperture 2, thereby causing an increase in the velocity of the material to be applied. It can also be gathered from the figure that the wide passage 3 terminates at the aperture 2, a certain distance h from the flat portion of the front end.

As may be gathered from FIGS. 3a to 3c, the aperture 2 opens into a slot 5, formed in the front end of the nozzle 1. The slot 5 is formed in the flat portion of the front end, with a constant depth h, that is down to the aperture 2. The slot 5 runs across the nozzle 1, whereby the slot 5 will also encompass two diametrically opposite portions of the conical surface. The slot 5 is cut down to the aperture 2 of the passage 3, allowing a free flow of material through the nozzle 1, from its rear end and out through the slot 5 at its front end.

FIG. 3c shows the nozzle 1 and its slot 5 in a cross-sectional view from another angle. In this figure, the slot 5 runs in the plane of the paper sheet. It will be evident from FIGS. 3a to 3c, that the aperture 2 is substantially more narrow than the passage 3, causing a large increase in speed as the material is pressed through the nozzle towards its aperture 2. As a result of this speed increase, the material will partially fill out the slot 5 before leaving the nozzle 1.

From when the slot 5 has been filled with material, there are substantially three routes by which to leave the nozzle, straight ahead through the flat front end of the nozzle, or through one of the two angled straight sides. In the preferred embodiment, the major portion of the material will pass out through the flat front end, for two reasons; partly because the end straight ahead is in line with the passage 3, not necessitating any directional change of the material, and partly because the width of the front flat end is larger than the width of the respective side portions. Ideally, the discussed design should cause the material to be ejected in three separate jets, one straight ahead and two obliquely towards the sides. Through a suitable shape of the nozzle 1, in particular the size of the cone angle and the shape of the slot 5, and an adaptation of that pressure at which the material is pressed through the nozzle, the three jets are however brought to converge due to the surface tension. This is illustrated in FIG. 3d, in which the nozzle is seen from the same angle as in FIG. 3c. As most of the material will pass through the flat front end, the two jets passing through the angled side portions will be deflected towards the centre jet by the forces of surface tension. The result will be, as illustrated in FIG. 3d, that the jet will be less conical than with prior art nozzles, allowing an enlarged working range.

FIG. 3d further illustrates the profile of the coating after having applied the material onto the substrate. The profile of the surface coating is clearly divided into three parts, as a consequence of three jets, even if held together, being used. It is furthermore evident, that the thickest portion of the coating is provided at the centre. This secures a good sealing of the joint and a high strength of the sealant coating.

The nozzle is particularly suitable for the application of sealant onto joints of car bodies. The nozzle provides a well-composed joint whilst reducing the consumption of sealant compared to prior art nozzles. Consequently, the nozzle is advantageous from a design aspect as well as an economical aspect.

In a preferred embodiment, the cone angle is φ=90°, whereby the flat front end of the truncated cone has a diameter of 4 mm. In such an embodiment, the slot 2 will have a length of 8.5 mm and a width of 0.45 mm. Such an embodiment is specifically adapted to one type of material, and with another type of material, the dimensions may need to be modified.

1. A nozzle (1) intended for the application of fluid materials, which at a front end thereof has an aperture (2) opening into a slot (5), which slot (5) has a central portion functioning to release most of the material straight ahead, and laterally directed side portions, characterised in that said slot (5) has a straight base at said aperture (2), opposing said central portion, and where said side portions extend between said straight base and said central portion, which side portions are functioning to distribute released material in a jet with a relatively even width.

2. The nozzle according to claim 1, characterised in that said central portion is straight and that said side portions are likewise straight, at a certain angle relative to the central portion.

3. The nozzle according to claim 1 or claim 2, characterised in that said front end is shaped like a truncated cone with a flat top, in which said slot (5) is formed, said slot (5) being divided into three portions, with a rectilinear central portion and two rectilinear side portions at an angle corresponding to the top angle (φ) of said cone.

4. The nozzle according to any one of the preceding claims, characterised by a relatively wide passage (3) running through the nozzle (1) from a rear end thereof to said aperture (2) at its front end.

5. The nozzle according to claim 4, characterised in that said passage (3) terminates in said aperture (2), at a certain distance (h) inside said front end, where it is met by said slot (5), which is relatively narrow, thereby causing a velocity increase in a material being pressed through the passage (3) and out through its aperture (2).

6. The nozzle according to claim 5, characterised in that said relatively wide passage (3) is provided with a narrower portion (4) right before the aperture (2).

7. The nozzle according to any one of the claims 3-6, characterised in that said truncated cone has a top angle (φ) of 90°.

8. The nozzle according to any one of the preceding claims, characterised in that the central portion of said slot (5) is longer than said side portions.

9. Use of a nozzle according to any one of the claims 1-8, characterised in that the nozzle is used for the application of sealant onto joints of car bodies.

10. Use of a nozzle according to any one of the claims 1-8, characterised in that the nozzle is used for the application of glue, in car bodies.

11. A nozzle (1) for the application of a fluid sealant, characterised in that the nozzle has an aperture (2) at a front end thereof, opening into a slot (5), which slot (5) has a central portion functioning to release most of the material straight ahead, and laterally directed side portions functioning to distribute released material in a jet with a relatively even width.

12. A nozzle (1) for the application of fluid glue, characterised in that the nozzle has an aperture (2) at a front end thereof, opening into a slot (5), which slot (5) has a central portion functioning to release most of the material straight ahead, and laterally directed side portions functioning to distribute released material in a jet with a relatively even width.

13. A nozzle (1) intended for the application of fluid materials, which at a front end thereof has an aperture (2) opening into a slot (5), which slot (5) has a central portion with a first length, functioning to release most of the material straight ahead, and laterally directed side portions, characterised in that said slot (5) has a straight base at said aperture (2), opposing said central portion and having a second length larger than said first length, and where said side portions extend between said straight base and said central portion, which side portions are functioning to distribute released material in a jet with a relatively even width.

14. A nozzle (1) intended for the application of fluid materials, which at a front end thereof has an aperture (2) opening into a slot (5), which slot (5) has a central portion with a first length, functioning to release most of the material straight ahead, and laterally directed side portions, characterised in that said slot (5) has a straight base at said aperture (2) extending straight through the nozzle, said straight base opposing said central portion and having a second length larger than said first length, and where said side portions extend between the ends of said straight base and the ends of said central portion, respectively, thereby facing obliquely forward, which side portions are functioning to distribute released material in a jet with a relatively even width.
